(19) United States
(12) Patent Application Publication
(10) Pub. No.: US 2014/0030587 A1
(43) Pub. Date: Jan. 30, 2014

(54) ELECTRIC STORAGE ELEMENT AND METHOD FOR MANUFACTURING THE SAME

(71) Applicant: GS Yuasa International Ltd., Kyoto-shi (JP)

(72) Inventors: Shogo Tsuruta, Kyoto-shi (JP); Syun Ito, Kyoto-shi (JP)

(73) Assignee: GS Yuasa International Ltd., Kyoto-shi (JP)

(21) Appl. No.: 13/953,683

(22) Filed: Jul. 29, 2013

(30) Foreign Application Priority Data
Jul. 30, 2012 (JP) 2012-168731

(51) Int. Cl. H01M 2/24

(52) U.S. Cl. CPC H01M 2/24
USPC 429/179; 29/623.1

(57) ABSTRACT

An electric storage element includes a casing, an electrode assembly arranged in the casing, a current collector arranged in the casing and connected to the electrode assembly, and a connection member penetrating through the casing and connected to the current collector. The current collector is provided with a fixing portion fixed to the casing. The fixing portion is located at a position opposite to a position where the electrode assembly is connected to the current collector with respect to a position where the connection member penetrates the casing.

### CROSS-REFERENCE TO RELATED APPLICATIONS

This application claims priority of Japanese Patent Application No.: 2012-168731 filed on Jul. 30, 2012, the content of which is incorporated herein by reference.

### FIELD

The present invention relates to an electric storage element and a method for manufacturing the same.

### BACKGROUND

A nonaqueous electrolyte secondary battery as an example of an electric storage element disclosed in JP 2004-111300 A includes, an electrode assembly, a current collector electrically connected to the electrode assembly, a terminal (connection member) electrically connected to the current collector, and a casing accommodating the electrode assembly and the current collector therein. The casing includes a case and a lid. The terminal penetrates through the lid.

The current collector of the nonaqueous electrolyte secondary battery disclosed in JP 2004-111300 A is caulking-fixed to the lid by an enlarged portion formed at a lower end of a terminal penetrating through the lid. Except for the caulking-fixed portion, the current collector is not fixed to the lid. For this reason, for example, when veneration is applied to the nonaqueous electrolyte secondary battery, stress is concentrated on the caulking-fixed portion of the current collector to which an electrode assembly having a relatively high weight is connected. The concentration of stress loosens the caulking fixation to form a gap, causing gas leakage from the case through the portion where the terminal penetrates the lid. In an electric storage element such as a nonaqueous electrolyte secondary battery, it is very important to secure gastightness, and the gas leakage from the casing cannot be overlooked.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

An object of the present invention is to improve fixing strength of the current collector to the casing.

A first aspect of the present invention provides an electric storage element comprising, a casing, an electrode assembly arranged in the casing, a current collector arranged in the casing and connected to the electrode assembly, and a connection member penetrating through the casing and connected to the current collector, wherein the current collector is provided with a fixing portion fixed to the casing, the fixing portion being located at a position opposite to a position where the electrode assembly is connected to the current collector with respect to a position where the connection member penetrates the casing.

A second aspect of the present invention provides a method for manufacturing an electric storage element, comprising, preparing a current collector that is accommodated in a casing together with an electrode assembly, has a connection portion connected to the electrode assembly, and is connected to a connection member penetrating through the casing, arranging the current collector on an inner side of the casing; and, fixing the current collector to the casing at a position opposite to the connection portion with respect to a position where the connection member penetrates through the casing.

According to the present invention, the current collector is provided with the fixing portion fixed to the casing at the portion opposite to the position where the electrode assembly is connected to the current collector with reference to the position where the connection member penetrates through the casing. This arrangement can enhance the fixing strength of the current collector to the casing. The enhancement of fixing strength can prevent the concentration of stress due to the vibration or the like on the connection member connected to the current collector, resulting in that positional deviation of the connection member can be prevented from occurring. By the prevention of positional deviation of the connection member, formation of a gap between the connection member and the casing can be prevented so that gas leakage from the casing through the gap can be effectively prevented. Since the position of the fixing portion is set on the opposite side of the position where the electrode assembly is connected to the current collector with reference to the position where the connection member penetrates the casing, interference between a device for welding or the like and the current collector can be prevented, offering favorable workability of an operation of fixing the fixing portion of the current collector to the casing.

### BRIEF DESCRIPTION OF DRAWINGS

The foregoing and the other features of the present invention will become apparent from the following description and drawings of an illustrative embodiment of the invention in which:

FIG. 1 is a perspective view showing an appearance of a nonaqueous electrolyte secondary battery according to a first embodiment of the present invention;

FIG. 2 is a sectional view along a line II-II in FIG. 1,

FIG. 3 is an enlarged view of a part III in FIG. 2;

FIG. 4 is an enlarged view of a part IV in FIG. 2;

FIG. 5 is a perspective view of a lid viewed from above;

FIG. 6 is a perspective view of a lid viewed from bottom;

FIG. 7 is an exploded perspective view of the lid viewed from above;

FIG. 8 is an exploded perspective view of the lid viewed from bottom;

FIG. 9 is a partial bottom view of the lid;

FIG. 10A is a partial bottom view of a lid showing another example of a welding fixing portion;

FIG. 10B is a partial bottom view of a lid showing still another example of the welding fixing portion;

FIG. 10C is a partial bottom view of a lid showing yet another example of the welding fixing portion;

FIG. 11 is a partial bottom view of a lid of a nonaqueous electrolyte secondary battery according to a second embodiment of the present invention;

FIG. 12 is a partial bottom view of a lid showing another example of a welding fixing portion;

FIG. 13 is a partial bottom view of a lid of a nonaqueous electrolyte secondary battery according to a third embodiment of the present invention;

FIG. 14A is a partial bottom view of a lid showing another example of a welding fixing portion;

FIG. 14B is a partial bottom view of the lid showing still another example of the welding fixing portion;

FIG. 14C is a partial bottom view of the lid showing yet another example of the welding fixing portion; and

FIG. 14D is a partial bottom view of the lid showing yet another example of the welding fixing portion.

### DESCRIPTION OF EMBODIMENTS

Hereinafter, an embodiment of the present invention will be described with reference to the accompanying drawings.

In the following description, terms indicating specific directions and positions (including “above”, “below”, “side”, “end”, and the like) are used as necessary. These terms are used just for the purpose of easier understanding of the invention with reference to the drawings, and the meanings of the terms should not restrict the technical scope of the present invention. Moreover, the following description provides merely an essential example, and should not be intended to restrict the present invention, application targets, or usage thereof.

### First Embodiment

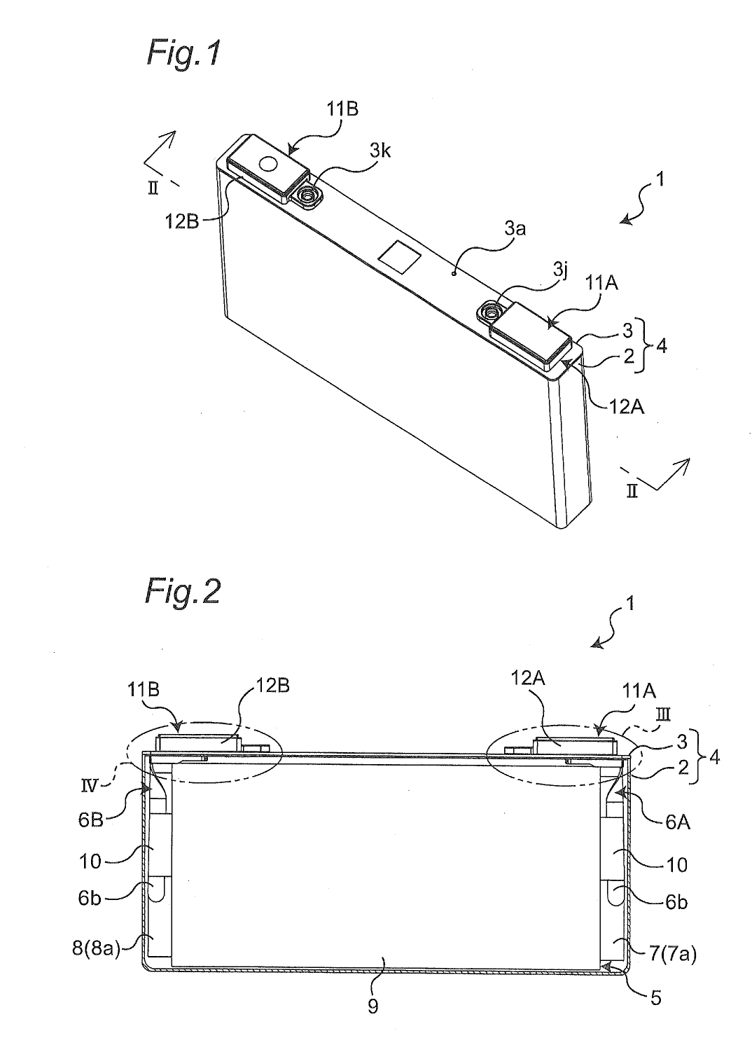

FIGS. 1 and 2 show a nonaqueous electrolyte secondary battery (to be simply referred to as a battery hereinafter) 1 according to a first embodiment of the present invention. A battery 1 is provided with a casing 4 including a case 2 and a lid 3 that sealingly closes an opening of the case 2. Accommodate inside the casing 4 are an electrode assembly 5, a positive current collector 6A, and a negative current collector 6B. An electrolytic solution is filled in the casing 4 through a liquid injection hole 3a formed in the lid 3.

The case 2 has a rectangular parallelepiped shape with an open upper end, and the lid 3 has an elongated rectangular shape corresponding to the shape of the case 2. In this embodiment, the case 2 and the lid 3 are made of such material as aluminum or an aluminum alloy.

The electrode assembly 5 includes a long-strip-shaped positive electrode sheet 7, a long-strip-shaped negative electrode sheet 8, and a long-strip-shaped separator 9 made of a finely porous resin. These sheets are laminated and wound in an elliptic-cylindrical shape with high ellipticity. In the embodiment, the positive electrode sheet 7 is a copper foil on which an active material is applied, and the negative electrode sheet 8 is an aluminum foil on which an active material is applied. Portions on which the active materials are not applied on the positive electrode sheet 7 and the negative electrode sheet 8 are respectively projected from the ends of the separator 9 in a width direction so as to configure a positive lead 7a and a negative lead 8a. The positive lead 7a is connected to one pair of legs (connection portions) 6b, 6b of the positive current collector 6A via a clip 10. The negative lead 8a is connected to one pair of legs (connection portions) 6b, 6b of the negative current collector 6B via a clip 10.

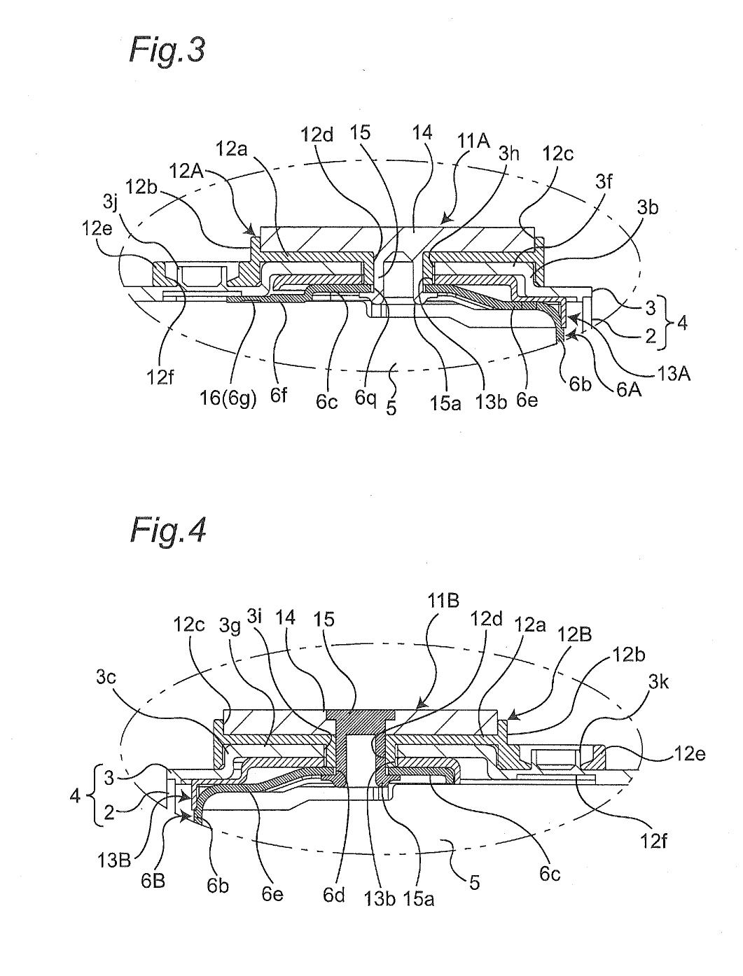

Further referring to FIGS. 3 to 8, formed near both ends of the lid 3 are receivers 3b and 3c protruding upward and having a substantially rectangular shape in a planar view. The lid 3 has a lower surface provided with shallow guide recesses 3d and 3e formed around the receivers 3b and 3c. Through holes 3h and 3i are respectively formed in top walls 3f and 3g of the receivers 3b and 3c.

As most clearly shown in FIGS. 3 and 4, on the upper sides of the receivers 3b and 3c, positive and negative external terminals (connection members) 11A and 11B are attached with upper gaskets 12A and 12B being respectively interposed therebetween. On the lower sides of the receivers 3b and 3c, the positive and negative current collectors 6A and 6B are attached with lower gaskets 13A and 13B being respectively interposed therebetween. Furthermore, formed on the lid 3 respectively at positions adjacent to the receivers 3b and 3c are engagement portions 3j and 3k having short-columnar shape projecting upward.

With reference to FIGS. 3, 7, and 8, the positive external terminal (connection member) 11A includes a flat plate (terminal) 14 and a substantially cylindrical shaft 15 integrated with the flat plate 14 and projecting downward. In this embodiment, the positive external terminal 11A is made of aluminum. With reference to FIGS. 4, 7, and 8, the negative external terminal (connection member) 11B includes a flat plate 14 and a cylindrical shaft 15. The cylindrical shaft 15 is a separate member from the flat plate 14, has an upper end to be fixed to the flat plate 14, and projects downward from the flat plate. The negative external terminal 11B in this embodiment includes the flat plate 14 made of aluminum and the shaft 15 made of copper. Conductive members (not shown) such as bus bars are to be respectively welded for connection to the flat plates 14, 14 of the positive and negative external terminals 11A and 11B.

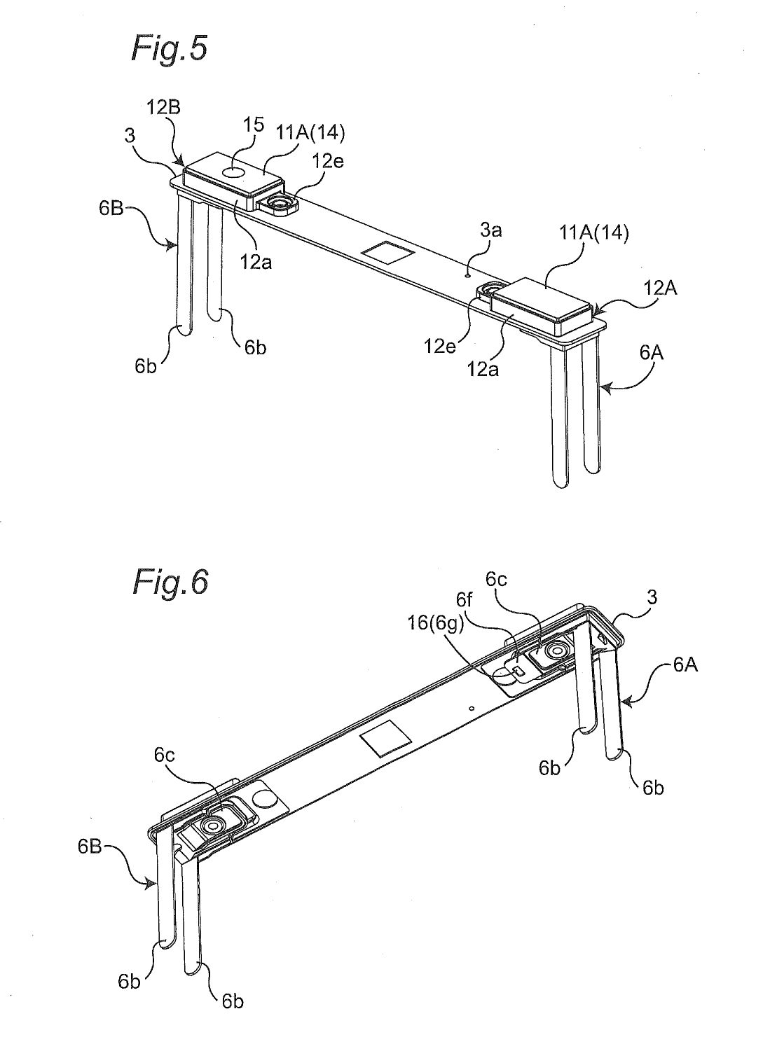

With reference to FIGS. 5 to 8, the positive current collector 6A includes a base 6a arranged along the lower surface of the lid 3 and having a substantially rectangular shape in a planar view, and one pair of legs (connection portions) 6b, 6b extending downward from one end of the base 6a in a longitudinal direction toward the bottom of the case 2. The base 6a includes a caulked portion 6c that is accommodated in the receiver 3b, protrudes upward, and has a substantially rectangular shape in a planar view. A through hole 6d for caulking-fixation is formed in the caulked portion 6c. The base 6a includes a pedestal 6e connected to one end of the caulked portion 6c in the longitudinal direction through a step. Proximal ends of one pair of legs 6b, 6b are connected to the pedestal 6e. Furthermore, the base 6a includes a substantially planar extension 6f connected to the other end of the caulked portion 6c in the longitudinal direction through a step. The positive current collector 6A in this embodiment is fabricated by press molding an aluminum plate material.

The negative current collector 6B has the same structure as that of the positive current collector 6A except that the negative current collector 6B does not include the extension 6f. More specifically, the negative current collector 6B includes the caulked portion 6c that is accommodated in the receiver 3c, protrudes upward, and has a substantially rectangular shape in a planar view, and the pedestal 6e that is connected to one end of the caulked portion 6c in the longitudinal direction through a step and to which the proximal ends of the pair of legs 6b, 6b are connected. The negative current collector 6B in this embodiment is fabricated by press molding a copper plate material.

With reference to FIG. 3 and FIGS. 5 to 8, in this embodiment, the upper gaskets 12A and 12B made of a resin include a partition 12a and a side wall 12b surrounding the partition 12a. In each of the upper portions of the upper gaskets 12A and 12B, an accommodation recess 12c is partitioned by the partition 12a and the side wall 12b. Each of the upper gaskets 12A and 12B includes a cylindrical portion 12d that projects from the center of the partition 12a downward and has openings at both the ends thereof. Furthermore, each of the upper gaskets 12A and 12B includes a tab-like portion 12e projecting from the side wall 12b. A through hole 12f is formed in the tab-like portion 12e.

With reference to FIGS. 4 and 5 to 8, in this embodiment, the lower gaskets 13A and 13B made of a resin include main bodies 13a that are accommodated in the receivers 3b and 3c of the lid 3, protrude upward, and have substantially rectangular shapes in a planar view. In the main body 13a, a through hole 13b for caulking and fixing is formed. Each of the lower gaskets 13A and 13B includes a fringe portion 13c connected to one end of the main body 13a through a step. The fringe portions 13c are arranged around the receivers 3b and 3c on the lower surface of the lid 3. The fringe portions 13c are not formed on the other ends of the main bodies 13a of the lower gaskets 13A and 13B.

As most clearly shown in FIGS. 3 and 4, the upper gaskets 12A and 12B cover the upper sides of the receivers 3b and 3c of the lid 3, and the flat plates 14 of the positive and negative external terminals 11A and 11B are respectively accommodated in the accommodation recesses 12c of the upper gaskets 12A and 12B. The engagement portions 3j and 3k of the lid 3 are respectively inserted into the through holes 12F formed in the tab-like portions 12e of the upper gaskets 12A and 12B from the lower sides thereof. On the other hand, the main bodies 13a of the lower gaskets 13A and 13B are respectively accommodated on the lower sides of the receivers 3b and 3c of the lid 3. The caulked portions 6c of the positive and negative current collectors 6A and 6B are respectively located on the lower sides of the main bodies 13a. The fringe portions 13c of the lower gaskets 13A and 13B are respectively interposed between the lower surface of the lid 3 and the pedestals 6e of the positive and negative current collectors 6A and 6B. The shafts 15 of the upper gaskets 12A and 12B respectively penetrate the through holes 3h and 3i in the top walls 3f and 3g of the receivers 3b and 3c on the lid 3 and the through holes 13b of the main bodies 13a of the lower gaskets 13A and 13B. The shafts 15 of the positive and negative external terminals 11A and 11B penetrate the cylindrical portions 12d of the upper gaskets 12A and 12B and penetrate the through holes 6d of the positive and negative current collectors 6A and 6B so as to extend down below the caulked portions 6c. The enlarged portions 15a are formed on the lower end sides of the shafts 15 of the positive and negative external terminals 11A and 11B to caulking-fix the positive and negative current collectors 6A and 6B to the lid 3 with the caulked portions 6c so that the positive and negative current collectors 6A, 6B and the positive and the negative external terminals 11A, 11B are electrically connected to each other. More specifically, interposed and held between the enlarged portions 15a of the shafts 15 of the positive and negative external terminals 11A and 11B and the flat plates 14 are the caulked portions 6c of the positive and negative current collectors 6A and 6B, the main bodies 13a of the lower gaskets 13A and 13B, the top walls 3f and 3g of the receivers 3b and 3c, and the partitions 12a of the upper gaskets 12A and 12B.

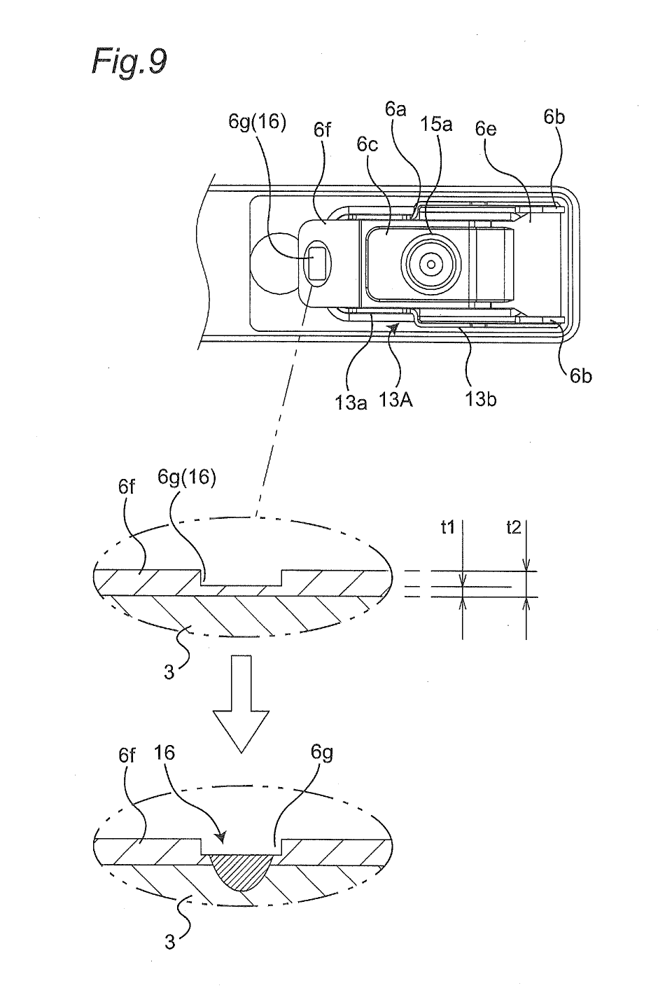

As most clearly shown in FIG. 9, the extension 6f of the positive current collector 6A is partially fixed to the lower surface of the lid 3 by welding. More specifically, a rectangular recess (thin portion) 6g is formed near the front end of the extension 6f on the lower-surface side, and the extension 6f and the lower surface of the lid 3 are welded by a laser or the like in the recess 6g to form a welding fixing portion 16. The welding fixing portion 16 is formed to electrically connect the positive current collector 6A to the aluminum casing 4 including the lid 3.

A thickness “t1” of the extension 6f of the positive current collector 6A at the recess 6g is preferably not less than 20% and not more than 70% of a thickness “t2” of the extension 6f around the recess 6g. In particular, the thickness “t1” is preferably not less than 20% and not more than 50% of the thickness “t2”. The thickness “t1” at the recess 6g is set to fall within the range to make it possible to rapidly form the welding fixing portion 16 having sufficient joint strength by welding using a laser or the like.

The welding fixing portion 16 is formed on a portion of the base 6a of the positive current collector 6A except for the portion where the shaft 15 of the positive external terminal 11A penetrates the base 6a of the positive current collector 6A, more specifically, the portion except for the portion where the base 6a of the positive current collector 6A is caulking-fixed by the shaft 15 of the positive external terminal 11A. More specifically, the welding fixing portion 16 is formed on the extension 6f located at the position opposed to the legs 6b, 6b with reference to the through hole 6d that is the position where the shaft 15 of the positive external terminal 11A penetrates the caulked portion 6c of the positive current collector 6A. When the battery 1 is subject to vibration, load is applied to the positive current collector 6A having the legs 6b, 6b connected to the electrode assembly 5 with a relatively heavy weight. However, the positive current collector 6A includes the caulked portion 6c not only caulked and fixed to the lid 3 by the shaft 15 of the positive external terminal 11A but also directly welded to the lid 3 by the welding fixing portion 16 formed on the extension 6f. More specifically, the positive current collector 6A is welded at the position different from the position where the positive current collector 6A is caulking-fixed, thereby moderating concentration of stress on the portion where the positive current collector 6A is caulking-fixed to the lid 3 by the shaft 15 of the positive external terminal 11A. As a result, when the battery 1 is subject to vibration, the caulking-fixation of the positive current collector 6A by the shaft 15 of the positive external terminal 11A can be prevented from being loosened, so that a gap that causes gas to leak from the inside of the case 2 can be reliably prevented from being formed in the portion where the shaft 15 of the positive external terminal 11A penetrates the lid 3. In this manner, the welding fixing portion 16 is formed so as to improve fixing strength of the positive current collector 6A to the lid 3.

The welding fixing portion 16 is formed on the extension 6f positioned on the opposite side of the legs 6b, 6b with respect to the position where the shaft 15 of the positive external terminal 11A penetrates the positive current collector 6A, that is, the position where the caulked portion 6c of the positive current collector 6A is caulking-fixed by the enlarged portions 15a formed at the lower end of the shaft 15. For this reason, when the positive current collector 6A is applied with a load due to vibration as described above, stress is not concentrated on only the welding fixing portion 16, and therefore the caulking and fixing of the caulked portion 6c by the shaft 15 of the positive external terminal 11A with high joint strength can reliably share resistance against the load. For this reason, the positive current collector 6A and the lid 3 at the welding fixing portion 16 can be prevented from being disconnected by the load applied to the positive current collector 6A due to vibration, and the electric connection between the positive current collector 6A and the casing 4 can be reliably prevented from being canceled. It is assumed that the positive external terminal 11A is connected to the lid 3 by welding or the like and electrically connected to the lid 3. In this case, an external force acting through the bus bar connected to the flat plate 14 (by welding in this embodiment) may disconnect the positive external terminal 11A from the lid 3. Heat generated when the bus bar is welded to the flat plate 14 may deteriorate connection strength of the positive external terminal 11A to the lid 3. Contrarily to this, in this embodiment, the positive external terminal 11A is electrically connected to the lid 3 through the positive current collector 6A, and the positive current collector 6A is electrically connected to the lid 3 at the welding fixing portion 16. The welding fixing portion 16 is located on the opposite side of the flat plate 14 of the positive external terminal 11A to which the bus bar is welded with respect to the position (the caulked portion 6c of the positive current collector 6A) where the positive external terminal 11A is caulking-fixed to the lid 3 together with the positive current collector 6A. For this reason, disconnection of the welding fixing portion 16 by the external force acting on the positive external terminal 11A through the bus bar and loosening of the welding fixing portion 16 due to heat generated when the bus bar is welded to the flat plate 14 can be prevented.

In case that a slit penetrating the base 6a of the positive current collector 6A in the direction of thickness is employed for forming the welding fixing portion 16 in place of the recess 6g, a punching process is necessary. Contrarily to this, the recess 6g to form the welding fixing portion 16 employed in the embodiment can be easily formed by press working.

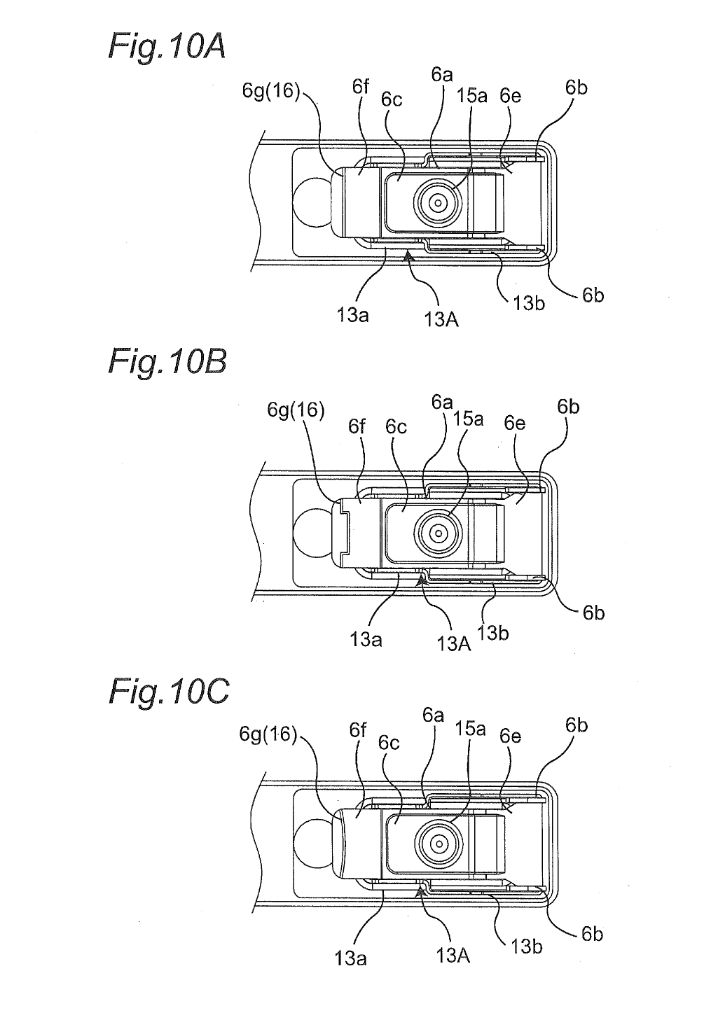

The shape of the recess 6g to form the welding fixing portion 16 is not limited to a rectangular shape as shown in FIG. 9. For example, as shown in FIG. 10A, one straight-groove-like recess 6g traversing the front end of the extension 6f may be formed. As shown in FIG. 10B, a broken-line-like recess 6g traversing the front end of the extension 6f configured by connecting a plurality of linear grooves may be formed. As shown in FIG. 10C, an arc-shaped recess 6g traversing the extension 6f may be formed.

A process for fixing the positive current collector 6A to the lid 3 will be generally described below.

The caulked portion 6c of the positive current collector 6A is located on the lower side of a receiver 3a of the lid 3 with the lower gasket 13A being interposed therebetween and the upper gasket 12A covers the upper side of the receiver 3a. The shaft 15 of the positive external terminal 11A is inserted into the cylindrical portion 12d of the upper gasket 12A, and the flat plate 14 of the positive external terminal 11A is accommodated in the accommodation recesses 12c of the upper gasket 12A. In this state, the enlarged portions 15a is formed at the front end of the shaft 15 projecting from the caulked portion 6c so that the positive current collector 6A is caulking-fixed to the lid 3.

The recess 6g is laser-welded while the extension 6f of the positive current collector 6A is brought into tight contact with the lower surface of the lid 3.

Since the recess 6g having a thickness smaller than that of the peripheral portion of the recess 6g is laser-welded as described above, the positive current collector 6A can be reliably welded to the lid 3 with a relatively low laser output. Since the laser output is low, an influence of heat in welding on the portion except for the recess 6g can be minimized. In particular, heat transmitted to the two gaskets at the portion where the positive current collector 6A is caulking-fixed to the lid 3, i.e., heat transmitted to the lower gasket 13A and the upper gasket 12A can be minimized. Heat influenced on the lower gasket 13A and/or the upper gasket 12A at the portion loosens the caulking-fixation obtained by forming the enlarged portions 15a on the shaft 15 of the external terminal 11A. The loosening of the caulking and fixing deteriorates gastightness of the portion where the shaft 15 of the external terminal 11A penetrates the lid 3. If not a portion such as the recess 6g having a small thickness (the thickness “t1” in FIG. 9) but a portion having a normal thickness (thickness t2 in FIG. 9) is to be laser-welded to the lid 3, a high laser output is necessary, resulting in that heat is also influenced on a portion distant from the welded portion. In particular, the heat is remarkably transmitted to the lower gasket 13A and/or the upper gasket 12A at the caulking-fixed portion to cause deterioration of gastightness by loosening of the caulking and fixing.

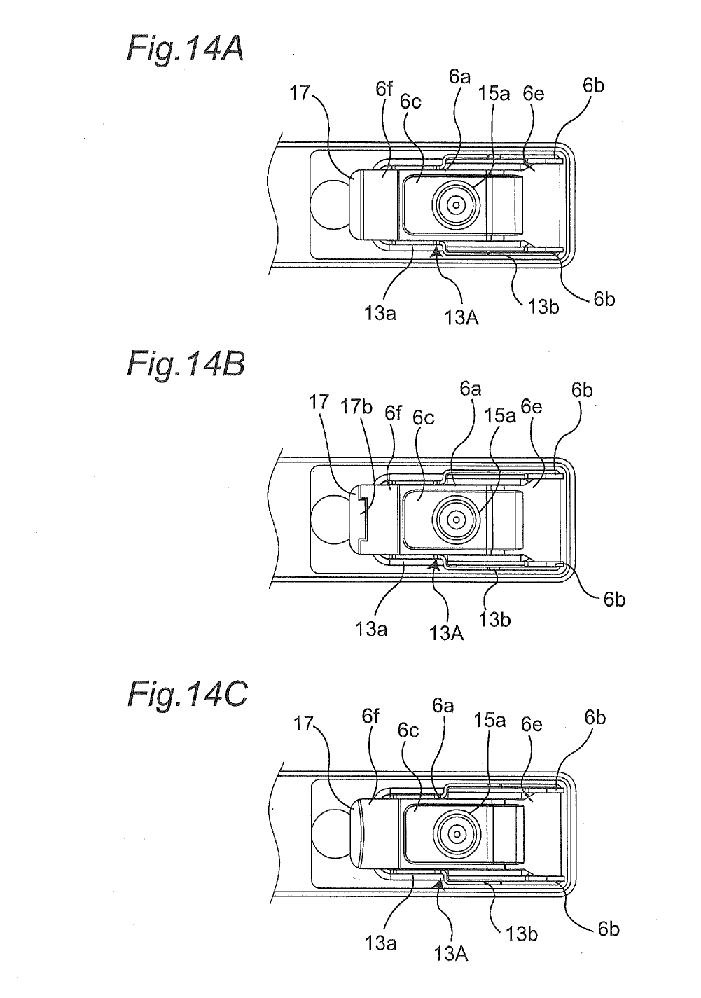

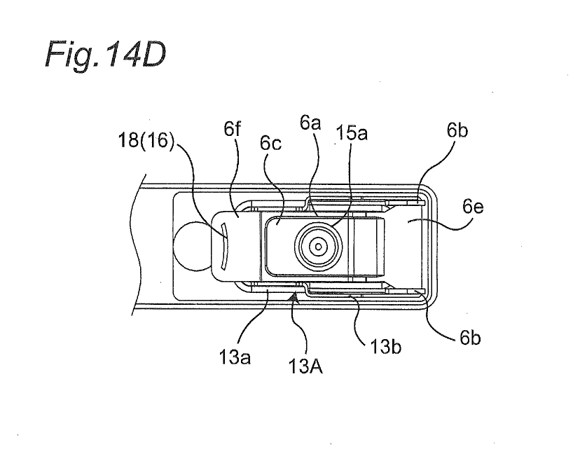

As described above, welding the recess 6a having the small thickness and formed in the positive current collector 6A can effectively suppress an influence of heat in welding with a simple configuration. In comparison with the case where a slit 18 (see FIG. 14D) that is formed in the extension 6f of the positive current collector 6A to penetrate the extension 6f in the direction of thickness is welded as in a third embodiment (will be described later), welding strength obtained when the recess 6a is welded in the embodiment is relatively low. However, as described above, the recess 6a (welding fixing portion 16) in this embodiment is located on the opposite side of the legs 6b, 6b with respect to the through hole 6d that is a position where the shaft 15 of the positive external terminal 11A penetrates through the caulked portion 6c of the positive current collector 6A. By the relative positional relationship between the caulking-fixed portion and the welding fixing portion 16, a load applied to the positive current collector 6A when the battery 1 is subject to vibration is mainly supported at a portion where the caulked portion 6c is caulking-fixed to the lid 3 by the shaft 15 of the positive external terminal 11A. As a result, although the strength is relatively lower than that obtained when the slit 18 (see FIG. 14D) is employed, even though the recess 6a having a small thickness is employed as in this embodiment, the welded portion of the positive current collector 6A to the lid 3 can be reliably prevented from being removed at the welding fixing portion 16. Since the welded portion to the lid 3 is not removed, electric connection of the positive current collector 6A to the lid 3 can be reliably maintained.

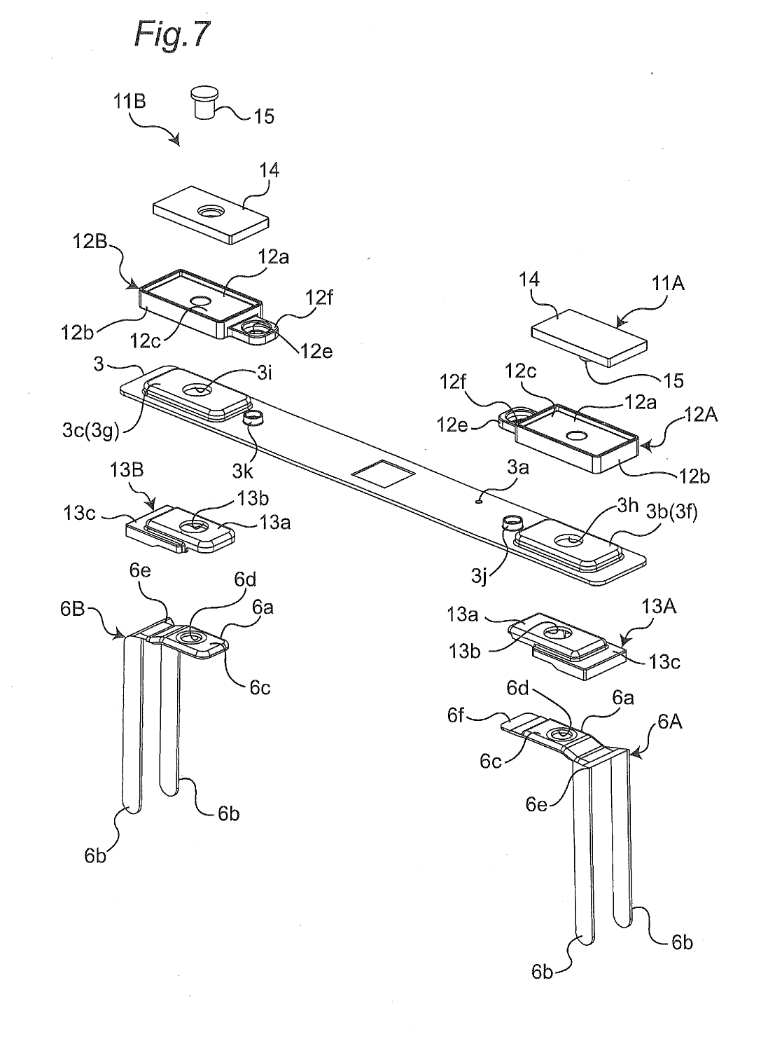

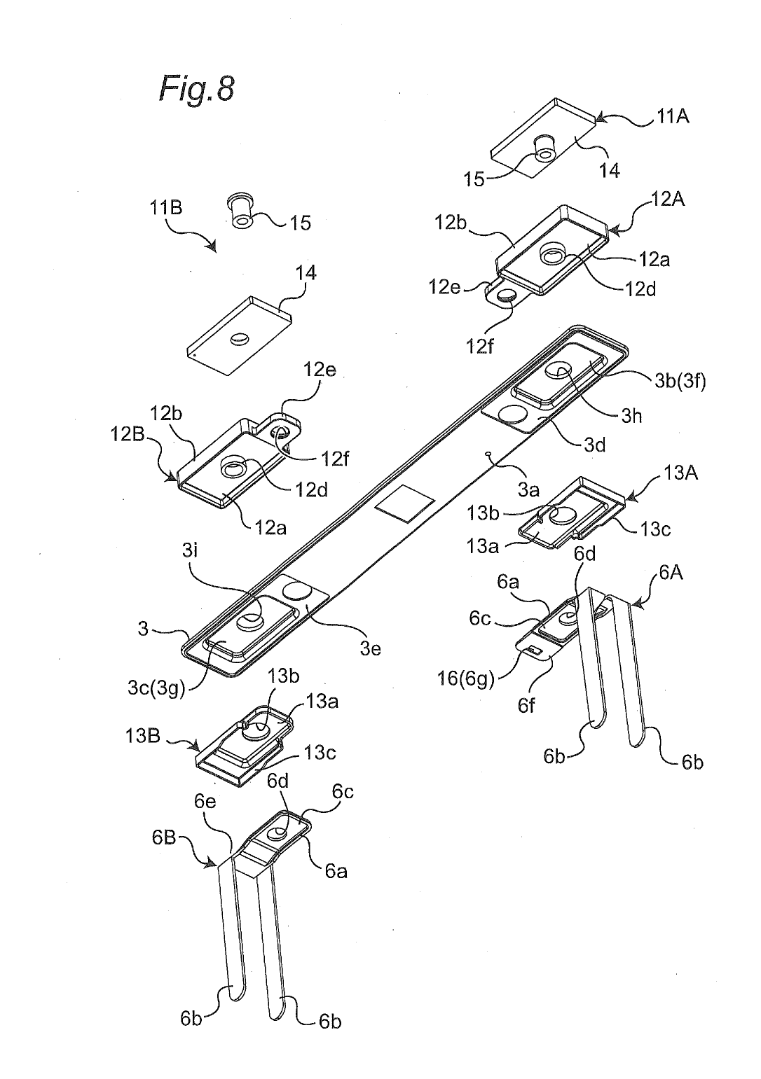

The recess 6g is arranged on the opposite side of the pair of legs 6b, 6b with respect to the portion where the shaft 15 of the positive external terminal 11A penetrates through the caulked portion 6c of the positive current collector 6A. More specifically, the laser-welded recess 6g is formed at the position distant from the legs 6b, 6b. For this reason, when the recess 6g is irradiated with a laser beam, a device such as a convergence optical system that converges a laser beam from a laser oscillator does not interfere with the legs 6b, 6b. More specifically, when the recess 6g that is a welding position is set to be a position distant from the legs 6b, 6b, the positive current collector 6A can be laser-welded to the lid 3 while the legs 6b, 6b are maintained in the original posture shown in FIGS. 7 and 8. The recess 6g that is the welding position arranged on the opposite side of the legs 6b, 6b can achieve favorable workability of welding operation.

As most clearly shown in FIG. 9, a surface of the extension 6f of the positive current collector 6A, which is the lid 3 side of recess 6g, is substantially flat and is in tight contact with the lower surface of the lid 3. For this reason, heat can be prevented from being locally concentrated on the portion where the recess 6g of the extension 6f is formed in laser welding, and therefore occurrence of distortion and crack can be reliably prevented.

### Second Embodiment

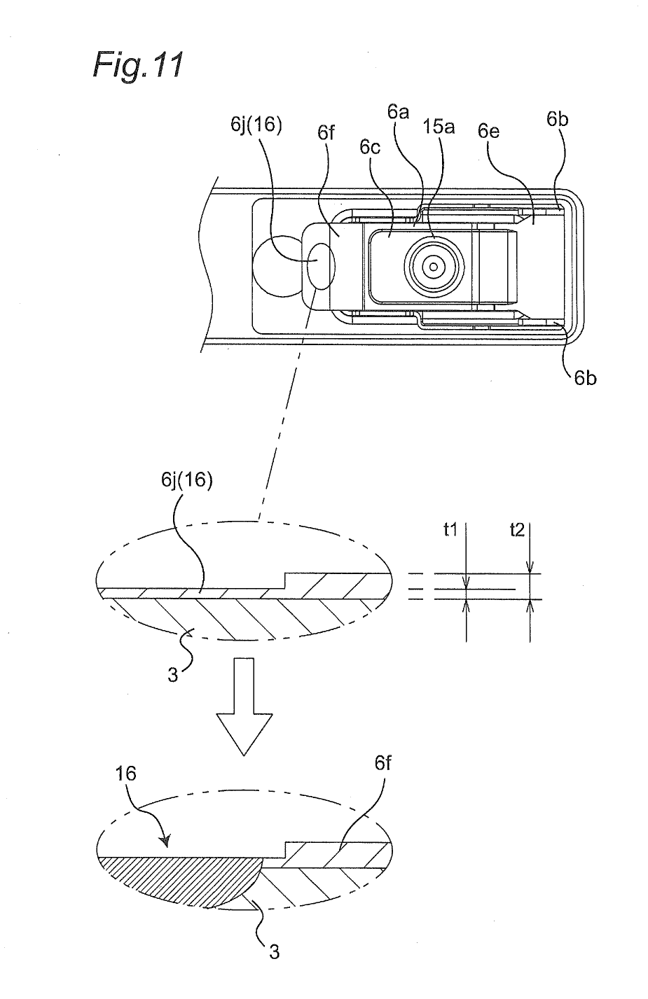

FIG. 11 shows a second embodiment of the present invention. The configuration of a battery according to the embodiment is the same as that of the first embodiment except for the structure of the welding fixing portion 16 (see FIGS. 1 to 8).

Formed at an edge of the front end of the extension 6f of the positive current collector 6A is a thin portion 6j having a thickness “t1” not less than 20% and not more than 70% (preferably, not less than 20% and not more than 50%) of a thickness “t2” of the other portion of the extension 6f. The extension 6f and the lower surface of the lid 3 are welded to each other at the thin portion 6j with a laser or the like to form the welding fixing portion 16.

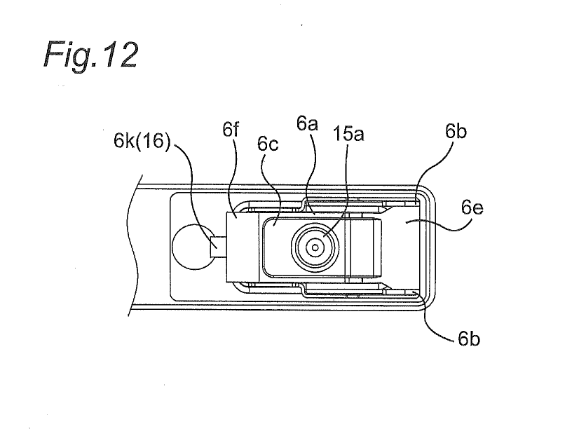

In FIG. 11, the width of the thin portion 6j is almost the same as the width of the extension 6f. However, as shown in FIG. 12, a tab-like thin portion 6k having a small width may be formed at the edge of the front end of the extension 6f.

### Third Embodiment

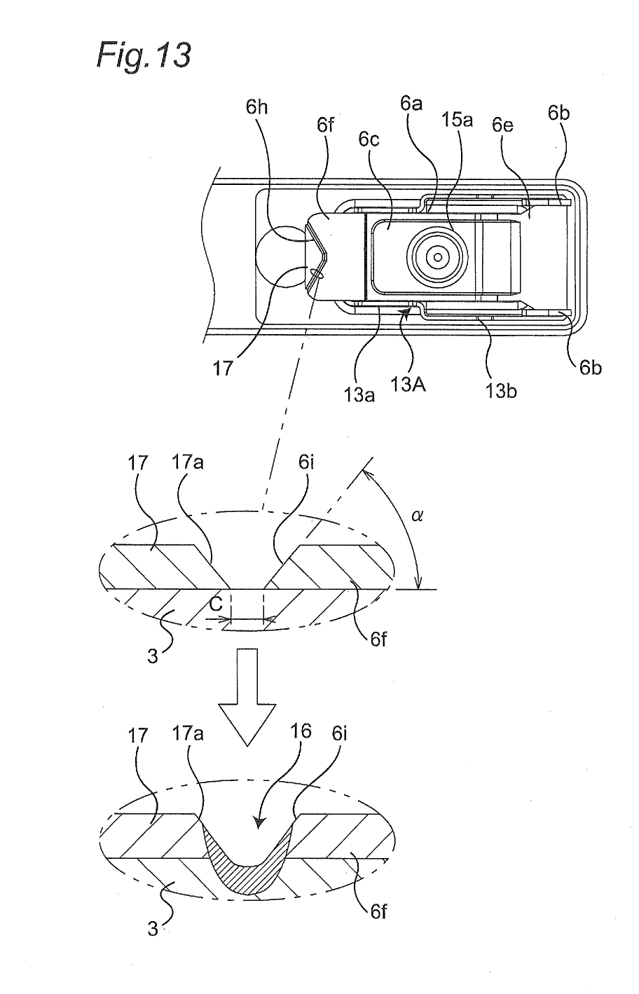

FIG. 13 shows a third embodiment of the present invention. The configuration of a battery according to the embodiment is the same as that of the first embodiment except for the structure of the welding fixing portion 16 (see FIGS. 1 to 8).

A substantially triangular connected notch 6h is formed at an edge of the front end of the extension 6f. An inclined surface 6i is formed in the notch 6h. In the notch 6h, a substantially triangular welding pad 17 made of the same material as that of the positive current collector 6A is arranged adjacently to the inclined surface 6i with a clearance “C”. An inclined surface 17a is also formed on the welding pad 17 along the notch 6h.

On the positive current collector 6A, the front end of the extension 6f is welded together with the welding pad 17 by a laser or the like to form the welding fixing portion 16. Angles α of the inclined surfaces 6i and 17a with a lower surface of the lid 3 need only be 30° or more and less than 90°. The clearance C (clearance at a boundary position between the inclined surfaces and the planar surface of the lid 3) need only be set to 0.2 to 0.3 mm. In this manner, in welding performed by a laser, a laser beam is applied in a direction perpendicular to the planar surface of the lid 3 to make it possible to simultaneously melt both the inclined surfaces 6i and 17a. The inclined surfaces 6i and 17a are located to be adjacent to each other with a narrow clearance “C” therebetween and gradually decrease in thickness toward the edges of the inclined surfaces 6i and 17a, respectively. For this reason, the inclined surfaces 6i and 17a are easily melted in welding on the lid 3 and melted in a large area. Thus, mechanical strength after solidification can be sufficiently enhanced.

The shape of the welding pad 17 to form the welding fixing portion 16 is not limited to a triangular shape shown in FIG. 13. For example, as shown in FIG. 14A, a substantially linear-strip-shaped welding pad 17 may be arranged. As shown in FIG. 14B, the welding pad 17 having a shape having a projecting portion 17b formed at the center in the longitudinal direction may be arranged. As shown in FIG. 14C, an edge facing the extension 6f may be provided with the arc-shaped welding pad 17.

As shown in FIG. 14D, in place of the welding pad 17, the slit 18 penetrating the extension 6f in the direction of plate thickness is formed in the extension 6f of the positive current collector 6A. One of edges of the slit 18 may be functioned as a welded portion and the other of them may be functioned as an auxiliary welding portion, so that the welding fixing portion 16 may be formed. As the shape of the slit 18, various shapes such as a V shape, a U shape, and a crank-like shape can be employed. By employing the slit 18, the welding pad 17 is unnecessary, and alignment to the positive current collector 6A is unnecessary, resulting in that the workability of welding is improved. When both the edges of the slit 18 are formed to form the same inclined surfaces as those in FIG. 13, a further excellent welding state can be obtained. When the inclined surfaces are simultaneously formed in press working for forming the positive current collector 6A, the inclined surfaces can be formed without increasing the number of process step.

In each of the first to third embodiments, the welding fixing portion 16 is formed to fix the base 6a of the positive current collector 6A to the lid 3 at the opposite portion of the legs 6b, 6b with respect to the through hole 6d of the caulked portion 6c. However, the portion may be fixed to the lid 3 by a method other than welding. The negative current collector 6B may be fixed to the lid 3 through the lower gasket 13B at the opposite portion of the legs 6b, 6b with respect to the through hole 6d of the caulked portion 6c.

What is claimed is:

1. An electric storage element comprising:
a casing;
an electrode assembly arranged in the casing;
a current collector arranged in the casing and connected to the electrode assembly; and
a connection member penetrating through the casing and connected to the current collector,
wherein the current collector is provided with a fixing portion fixed to the casing, the fixing portion being located at a position opposite to a position where the electrode assembly is connected to the current collector with respect to a position where the connection member penetrates the casing.

2. The electric storage element according to claim 1, wherein the current collector includes a base that is located on an inner surface of the casing and through which the connection member penetrates and a connection portion that projects from the base inside the casing and to which the electrode assembly is connected, and
wherein the fixing portion is formed on the base at a position opposite to the connection portion with respect to the position where the connection member penetrates through the base.

3. The electric storage element according to claim 2, wherein the connection member includes a terminal portion arranged outside the casing and a shaft projecting from the terminal portion inside the casing so as to penetrate through the lid and the base of the current collector, the base of the current collector being caulking-fixed between the shaft and the casing, and
wherein the fixing portion is formed on the base at a position opposite to the connection portion with respect to a position where the base of the current collector is caulking-fixed between the shaft and the casing.

4. The electric storage element according to claim 3, further comprising first gasket arranged between the terminal portion of the connection member and the casing and between the shaft of the connection member and a portion of the casing through which the shaft penetrates.

5. The electric storage element according to claim 4, comprising a second gasket that is arranged between the casing and the current collector and thorough which the shaft penetrates.

6. The electric storage element according to claim 1, wherein the fixing portion is formed by fixing the current collector to the casing by welding.

7. The electric storage element according to claim 6, wherein the fixing portion is formed by fixing a thin portion formed on the current collector to the casing by welding.

8. The electric storage element according to claim 7, wherein a first thickness that is a thickness of the current collector at the thin portion before welding is not less than 20% and not more than 70% of a second thickness that is a thickness of the current collector around the thin portion.

9. The electric storage element according to claim 8, wherein the first thickness is not less than 20% and not more than 50% of the second thickness.

10. The electric storage element according to claim 1, wherein the thin portion is a recess.

11. The electric storage element according to claim 10, wherein a portion of the current collector where the recess is formed has a flat surface on the casing side.

12. The electric storage element according to claim 1, wherein the current collector is a positive current collector.

13. The electric storage element according to claim 12, wherein the positive current collector is electrically connected to the casing by the fixing portion.

14. The electric storage element according to claim 13, wherein the casing is made of aluminum.

15. The electric storage element according to claim 1, wherein the casing includes a case that accommodates the electrode assembly and the current collector therein and a lid that closes an opening of the case, and
wherein the current collector is fixed to the lid by the fixing portion.

16. A method for manufacturing an electric storage element, comprising:
preparing a current collector that is accommodated in a casing together with an electrode assembly, has a connection portion connected to the electrode assembly, and is connected to a connection member penetrating through the casing;
arranging the current collector on an inner side of the casing; and
fixing the current collector to the casing at a position opposite to the connection portion with respect to a position where the connection member penetrates through the casing.
